(19) United States
(12) Patent Application Publication
(10) Pub. No.: US 2018/0229427 A1
(43) Pub. Date: Aug. 16, 2018

(54) MANUFACTURING METHOD AND MANUFACTURING DEVICE FOR THREE-DIMENSIONAL OBJECT

(71) Applicant: MIMAKI ENGINEERING CO., LTD., NAGANO (JP)

(72) Inventors: KAZUHIRO OCHI, NAGANO (JP); KAZUYUKI TAKEUCHI, NAGANO (JP)

(73) Assignee: MIMAKI ENGINEERING CO., LTD., NAGANO (JP)

(21) Appl. No.: 15/880,533

(22) Filed: Jan. 26, 2018

(30) Foreign Application Priority Data
Feb. 16, 2017 (JP) 2017-027318

(51) Int. Cl. B29C 64/112; B29C 64/209; B29C 64/393; B33Y 10/00; B33Y 30/00; B33Y 50/02

(52) U.S. Cl. CPC B29C 64/112; B29C 64/209; B33Y 50/02; B33Y 10/00; B33Y 30/00; B29C 64/393

(57) ABSTRACT

Even when dots of ink for forming layers that constitute a three-dimensional object are reduced in size to produce a gap therebetween, the present disclosure suppresses an adverse effect caused by the gap. A control part in a manufacturing device for a three-dimensional object controls a head, such that the center of an ink droplet ejected for forming a segment layer does not overlap the center of an ink droplet that forms another segment layer immediately below, and that the ink droplet is ejected at a resolution different from the resolution of the other segment layer immediately below the segment layer being formed.

### CROSS REFERENCE TO RELATED APPLICATIONS

This application claims the priority benefit of Japanese Patent Application No. 2017-027318, filed on Feb. 16, 2017. The entirety of the above-mentioned patent application is hereby incorporated by reference herein and made a part of this specification.

### TECHNICAL FIELD

The present disclosure relates to a manufacturing method and a manufacturing device for a three-dimensional object.

### DESCRIPTION OF THE BACKGROUND ART

Japanese Unexamined Patent Publication No. 2007-531641 (published on Nov. 8, 2007) describes a method of producing a three-dimensional object by planarizing a flowable build material using a roller.

Patent Literature 1: Japanese Unexamined Patent Publication No. 2007-531641 (published on Nov. 8, 2007)

### SUMMARY

When a shaped object is manufactured by depositing layers one after another, it is common to deposit material layers one after another at the same location in the planar direction. In other words, for example, when a shaped object is manufactured using an inkjet device, the nozzle for ejecting ink to the particular location is the same throughout the deposition process.

When the material is supplied in this manner, the surface of the layers deposited becomes rough because the amount of ejection and the accuracy in droplet placement vary among nozzles. Then, for example, as described in Japanese Unexamined Patent Publication No. 2007-531641, there is a known method that eliminates the surface using a planarization mechanism, such as a roller, after supplying the material.

Planarization by a roller removes the supplied material. As the after-material supply increases, the amount of material to be removed by the roller would increase.

The present disclosure is made in view of the problem as described above and provides a manufacturing method for a three-dimensional object that can improve planarity by reducing the surface roughness of layers, when a three-dimensional object is constructed by depositing layers.

In order to solve the problem above, the present disclosure provides a manufacturing method for a three-dimensional object for manufacturing a three-dimensional object by depositing segment layers. In the manufacturing method for a three-dimensional object, droplets are ejected such that the center of a droplet of at least a part of the droplets ejected from a head for forming a segment layer does not overlap the center of a droplet that forms another segment layer immediately below, and the droplets are ejected at a resolution different from the resolution of the other segment layer immediately below the segment layer being formed.

The present disclosure provides a manufacturing device for a three-dimensional object for manufacturing a three-dimensional object by depositing segment layers. The manufacturing device for a three-dimensional object includes a head control part configured to control a head for ejecting droplets. The head control part controls the head such that a center of a droplet of at least a part of the droplets ejected for forming a segment layer does not overlap a center of a droplet that forms another segment layer immediately below and that the droplets are ejected at a resolution different from the resolution of the other segment layer immediately below the segment layer being formed.

Droplets in the overlying segment layer are ejected with a resolution changed so as not to overlap the center of the dot of a droplet in the underlying segment layer, whereby at least part of the droplet fills between dots of droplets in the underlying segment layer, with simple control. This reduces the surface roughness of the segment layer.

In the manufacturing method for a three-dimensional object according to the present disclosure, it is preferable that the droplets ejected from the head have variable amounts according to the resolution.

The diameters of the dots are changed to facilitate placement of droplets between dots of droplets that form the underlying segment layer. For example, a segment layer with high resolution is formed with small dots, so that the depressions in the segment layer immediately below can be filled with ink efficiently. For example, when a segment layer with high resolution is formed with large dots, the segment layer immediately below can be covered together with the depressions, and thus this processing can also planarize the surface roughness. Accordingly, the roughness of the segment layer can be planarized efficiently.

In the manufacturing method for a three-dimensional object according to the present disclosure, the three-dimensional object is manufactured by depositing unit layers each including a plurality of segment layers. It is preferable that the number of segment layers included in the unit layer be equal in at least part of the three-dimensional object, and that in each of the unit layers formed with an equal number of segment layers, a resolution is set lower in a segment layer on a lower side in a gravity direction.

When a segment layer other than the lowest layer in each unit layer is formed, an ink droplet can be suitably placed in a gap between dots of droplets in the segment layer immediately below.

In the manufacturing device for a three-dimensional object according to the present disclosure, it is preferable that, among the segment layers, the resolution of at least a part of other segment layers different from a segment layer with a lowest resolution is set to 2ⁿ times the lowest resolution, where n is an integer equal to or greater than 1.

Dots in the segment layer with high resolution are arranged at four corners of the segment layer with low resolution, thereby efficiently filling the depressions at corners.

In the manufacturing device for a three-dimensional object according to the present disclosure, the droplets are ejected at a resolution different from the resolution of the other segment layer immediately below the segment layer being formed and a resolution 2ⁿ times or (½)ⁿ times the resolution of the segment layer immediately below, where n is an integer equal to or greater than zero, and an upper limit of n is a predetermined value.

This control allows an ink droplet to be placed at a distance away from the center of the dot in the underlying segment layer. Accordingly, the dots can be arranged across the respective pixel regions between the segment layers adjacent to each other in the deposition direction, thereby achieving the effect of suppressing banding (striping). This can further planarize the surface roughness.

In the manufacturing method for a three-dimensional object according to the present disclosure, it is preferable that the method include a pressure application step in which pressure is applied to planarize an outermost surface of the unit layer.

Pressure is applied to the outermost surface of the unit layer to facilitate intrusion of dots in the segment layer on the upper side between dots in the segment layer on the lower side in a unit layer, thereby promoting planarization efficiently. In particular, in a mode in which the amount of ejection is changed such that the dot diameter decreases as the resolution increases, a small dot in the segment layer on the upper side easily intrudes between large dots in the segment layer on the lower side, which enables more effective planarization.

According to the present disclosure, improved planarity can be achieved by reducing the surface roughness of layers when a three-dimensional object is constructed by depositing layers.

### BRIEF DESCRIPTION OF THE DRAWINGS

FIG. 1 is a schematic diagram illustrating a configuration of a manufacturing device for a three-dimensional object according to an embodiment of the present disclosure and a three-dimensional object manufactured by the same.

FIG. 2 is a diagram schematically illustrating an an arrangement of ink drops that constitute a segment layer formed by the manufacturing device for a three-dimensional object according to an embodiment of the present disclosure.

FIG. 3 is diagram schematically illustrating an arrangement of ink drops that constitute a segment layer formed by another embodiment of the present disclosure.

FIG. 4 is a diagram schematically illustrating the procedure for manufacturing a three-dimensional object M using the manufacturing device 100 for a three-dimensional object, as an embodiment of a nozzle inspection method.

FIG. 5 is a diagram schematically illustrating an overall configuration of a head 1 in the manufacturing device 100 for a three-dimensional object for use in an embodiment of the nozzle inspection method.

### DESCRIPTION OF EMBODIMENTS

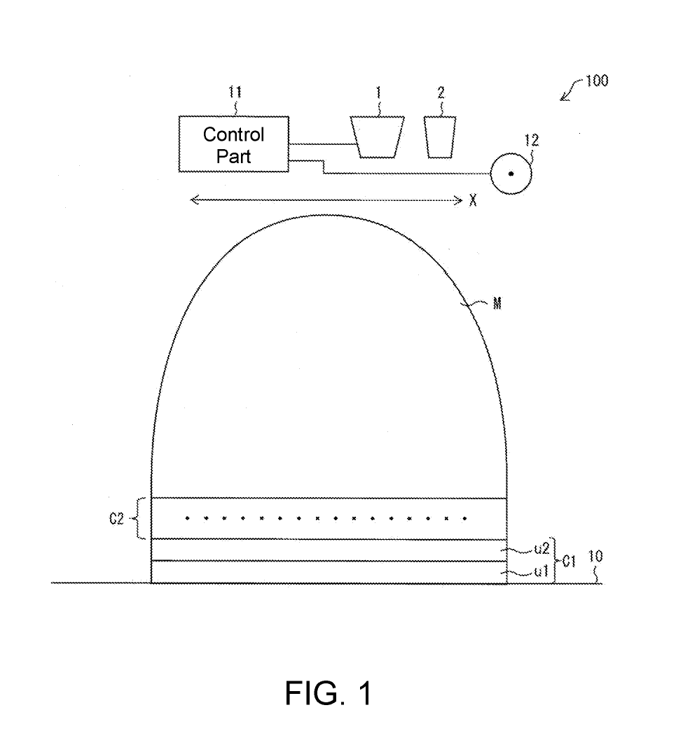

An embodiment of the present disclosure is described with reference to FIG. 1.

[Configuration of Manufacturing Device for Three-Dimensional Object]

FIG. 1 is a schematic diagram illustrating a configuration of a manufacturing device for a three-dimensional object according to an embodiment of the present disclosure and a three-dimensional object manufactured by the same.

As illustrated in FIG. 1, a manufacturing device 100 for a three-dimensional object includes a head 1, a UV-LED lamp 2, a support stage 10, a control part 11 (head control part), and a roller 12.

As illustrated in FIG. 1, a three-dimensional object M is manufactured by depositing a plurality of segment layers. A part of the segment layers are denoted by reference numerals and called segment layers u1, u2. In this specification, when a three-dimensional object is manufactured by depositing layers formed of ink, a minimum unit of the deposited layers is referred to as a “segment layer”. In this specification, a set of a plurality of segment layers is referred to as a “unit layer”. That is, the three-dimensional object M is manufactured by depositing a plurality of unit layers such as unit layers C1, C2.

(Head 1)

The head 1 is for ejecting ink (droplets). A conventionally known inkjet head can be used suitably.

A conventionally known model material may be employed as ink for forming a three-dimensional object M. Photocurable ink is preferred, and especially ultraviolet (UV) curable ink is preferred. This is because photocurable ink, especially ultraviolet (UV) curable ink, can easily be hardened and therefore enables manufacturing of a three-dimensional object in a short time. In the present embodiment, a model material of UV curable ink is used by way of example.

UV curable ink includes a UV curable compound. Non-limiting examples of the UV curable compound include a compound that hardens when being radiated with ultraviolet light. Examples of the UV curable compound include curable monomers and curable oligomers which are polymerized by application of ultraviolet radiation. Examples of the curable monomers include low-viscosity acrylic monomers, vinyl ethers, oxetane monomers, and cyclic aliphatic epoxy monomers. Examples of the curable oligomers include acrylic oligomers.

When a three-dimensional object to be manufactured has an overhang portion, a conventionally known support material may be used as necessary.

The UV-LED lamp 2 is for applying ultraviolet radiation to the UV curable ink ejected from the head 1 to harden the ink. More specifically, in the present embodiment, the ink ejected from the head 1 is hardened with the UV-LED lamp 2 to form segment layers, which are deposited one after another.

(Support stage 10)

The support stage 10 is a stage on which a three-dimensional object M to be manufactured rests. The segment layer u1 which is the lowest layer in the three-dimensional object M is formed on the support stage 10.

(Control Part 11)

The control part 11 controls the head that ejects ink. Specifically, the control part 11 controls the head 1 such that the center of an ink droplet of at least part of the ink ejected for forming a segment layer does not overlap the center of an ink droplet that forms the segment layer immediately below, and that ink is ejected at a resolution different from the resolution of the segment layer immediately below the segment layer being formed. By doing so, a gap between ink drops in the segment layer immediately below can be filled with the newly ejected ink droplet, and the surface roughness can be reduced with simple control. Thus, a finer three-dimensional object M can be manufactured.

In addition, the control part 11 controls the pressure of the roller 12 applied to the surface of a segment layer. For example, the control part 11 controls at what timing and what degree of pressure the roller 12 applies. The degree of pressure applied is adjusted with, for example, the rotation speed and the height at which the roller 12 is brought into contact.

In the present embodiment that is described below, the manufacturing method for a three-dimensional object according to the present disclosure is implemented by operating the manufacturing device 100 for a three-dimensional object using the control part. The present disclosure, however, is not limited to such an embodiment, and the operation for implementing the manufacturing method for a three-dimensional object according to the present disclosure may be performed manually.

(Roller 12)

The roller 12 applies pressure to the surface of a segment layer. In the present disclosure, the member for applying pressure to the surface of a segment layer is not limited to a roller, and, for example, pressure may be applied by pressing a plate-shaped member.

[Method of Manufacturing Three-Dimensional Object]

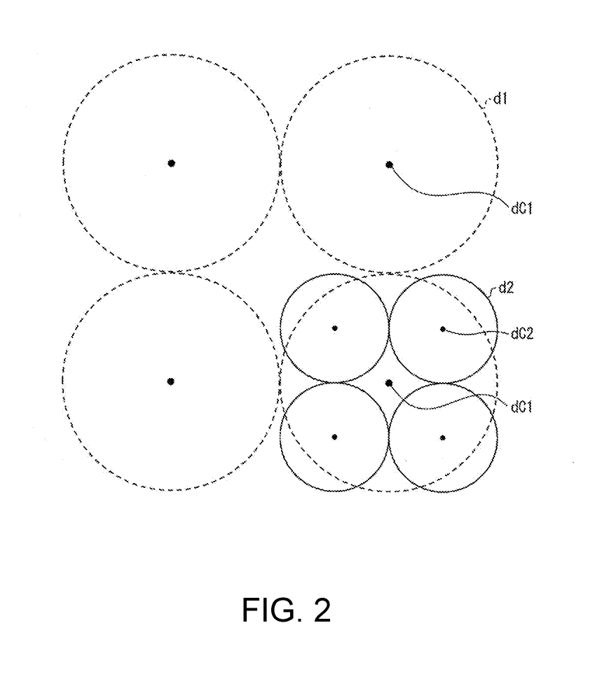

A more specific manufacturing method for a three-dimensional object in the present embodiment is now described with reference to FIG. 2. FIG. 2 is a diagram schematically illustrating an arrangement of ink drops that constitute segment layers u1 and u2. A dot d1 is one of ink drops that form the segment layer u1 and has its center at a center dC1. A dot d2 is one of ink drops that constitute the segment layer u2 immediately above the segment layer u1.

First of all, the control part 11 determines whether a mode of manufacturing a three-dimensional object M being the mode for finer manufacturing. Whether to set this mode is determined by a user. More specifically, when this mode is not set, segment layers are produced at the same resolution without performing control such that the center of a dot of ink does not overlap the center of a dot immediately below. When it is determined that this mode is set, a three-dimensional object M is manufactured as follows.

The control part 11 controls the head 1 such that printing is performed at a resolution of 150 dpi when the segment layer u1 is manufactured. Ink is thus ejected from the head 1 onto the support stage 10.

Here, to fill the area of the region for forming the segment layer with ink at the resolution of 150 dpi as specified above, the control part 11 controls the head 1 to eject the ink in an amount such that the diameter of the dot d1 of the ink forming the segment layer u1 is larger than the diameter of the dot d2 of the ink forming the segment layer u2, which is formed by printing in higher resolution. Specifically, since printing is performed at 300 dpi for forming the segment layer u2, the amount of ejection is set such that the diameter of the dot d1 is twice the diameter of the dot d2.

Although the present embodiment describes a case in which ink is ejected at resolutions of 150 dpi and 300 dpi, the resolution is not limited thereto. It is preferable that the amount of ejection of ink be changed according to the resolution as in the present embodiment, because if so, droplets of ink can be easily placed between dots of ink in the underlying segment layer. However, the present disclosure is not limited to such an embodiment.

While the head 1 reciprocates in the direction of the arrow X (main scanning direction), the support stage 10 moves in the sub scanning direction, which is orthogonal to the main scanning direction and parallel to the planar direction of the support stage 10. The segment layer u1 is thus formed on the support stage 10.

Next, the segment layer u2 is formed on the segment layer u1. When the segment layer u2 is formed, the control part 11 controls the head 1 such that ink is ejected at a resolution of 300 dpi. The diameter of the dot d2 of ink injected at this time is half the diameter of the dot d1. This is because the same unit area is filled with four times the number of dots. In other words, the control part 11 performs control of changing the amount of ink according to the resolution so as to achieve such a diameter.

When ink is ejected in this manner, droplets are placed such that the center dC2 of the dot d2 does not overlap the center dC1 of the dot d1, as illustrated in FIG. 2. The gap formed between a plurality of dots d1 is filled with the dot d2. Accordingly, the surface of the segment layer u2 is better planarized, for example, than the case in which the same location and the same resolution are used for forming both the segment layer u2 and the segment layer u1.

The control part 11 controls the head 1 to form two segment layers constituting the unit layer C2 in the same respective conditions as those of the segment layer u1 and the segment layer u2. More specifically, formation of a segment layer at 150 dpi and formation of a segment layer at 300 dpi are repeated to manufacture the three-dimensional object M.

As in the present embodiment, a segment layer with a low resolution and a segment layer with a resolution 2ⁿ times the low resolution (n is an integer equal to or greater than 1) are provided, whereby dots of the segment layer with high resolution are arranged at four corners of the segment layer with low resolution, thereby efficiently filling the depressions at the corners. In the present embodiment, supposing that the dot d1 at the lower right in FIG. 2 is located on the lower rightmost side of the segment layer, a gap appears at the lower right of the dot d1 but the gap can be filled with a part of the dot d2.

As used herein, the “gap” refers to a portion where an actual dot is not formed and a portion where the thickness of an ink droplet to form a dot is thinner than the central portion. When the dot size formed by an ink droplet is larger than the pixel size to form a predetermined resolution, an ink droplet is placed in the gap at the edge of the dot thinner than the thickness of the central portion in the segment layer immediately below, thereby reducing the difference between the thickness of the ink droplet at the edge of the dot, which is a gap in the segment layer immediately below, and the thickness of the central portion.

Furthermore, as in the present embodiment, the head 1 is controlled such that the resolution is lower in the segment layer on the lower side in the gravity direction in each of the unit layers C1, C2 . . . , each including the same number of segment layers, namely, two layers, whereby when a segment layer other than the lowest layer is formed in each unit layer, an ink droplet can be placed suitably in a gap between dots of ink in the segment layer immediately below. The present disclosure, however, is not limited to such an embodiment. For example, the resolution on the lower side may be lower and the resolution on the upper side may be higher. For example, the gap formed at the center of four dots having the same diameter as the dot d2 can also be filled by placing an ink droplet having the same diameter as the dot d1.

Next, in order to further smooth the surface of the unit layer, the roller 12 is rolled over the surface (pressure application step). In the present embodiment, the segment layer on the upper side in a unit layer has a higher resolution (the dots are smaller). Thus, the roller 12 can further promote a small dot to be set in the segment layer on the upper side between large dots in the segment layer on the lower side. This enables even more efficient planarization.

Furthermore, performing the process with the roller 12 for each unit layer has the advantage over performing the process with the roller 12 for each segment layer, in that the amount of ink adhering to and scraped off the roller 12 when pressed by the roller 12 is reduced and that the manufacturing speed is increased.

Timing and degree of the pressure of the roller 12 may be controlled by the control part 11, which controls the head 1, or by another control part. It may also be controlled manually.

As described above, in the present embodiment, the head is controlled such that the resolution for each segment layer is changed so that the center of an ink droplet of at least part of ink ejected for forming a segment layer does not overlap the center of an ink droplet forming the segment layer immediately below.

Furthermore, the present embodiment also describes the case in which the resolutions of constituent segment layers and the order they are deposited are the same among different unit layers. In other words, a segment layer at 300 dpi is deposited on a segment layer at 150 dpi in one unit layer, which is applicable to other unit layers. The present disclosure, however, is not limited to such an embodiment, and the resolutions of constituent segment layers may be completely different among unit layers. The number of segment layers that form a unit layer may also vary.

The present embodiment is also an embodiment of the manufacturing method for a three-dimensional object according to the present disclosure, in which the center of an ink droplet of at least part of ink ejected for forming a segment layer does not overlap the center of an ink droplet that forms the segment layer immediately below, and ink is ejected at a resolution different from that of the segment layer immediately below the segment layer being formed. In this way, the manufacturing method for a three-dimensional object according to the present disclosure can be implemented suitably using the manufacturing device for a three-dimensional object according to the present disclosure.

(Modification)

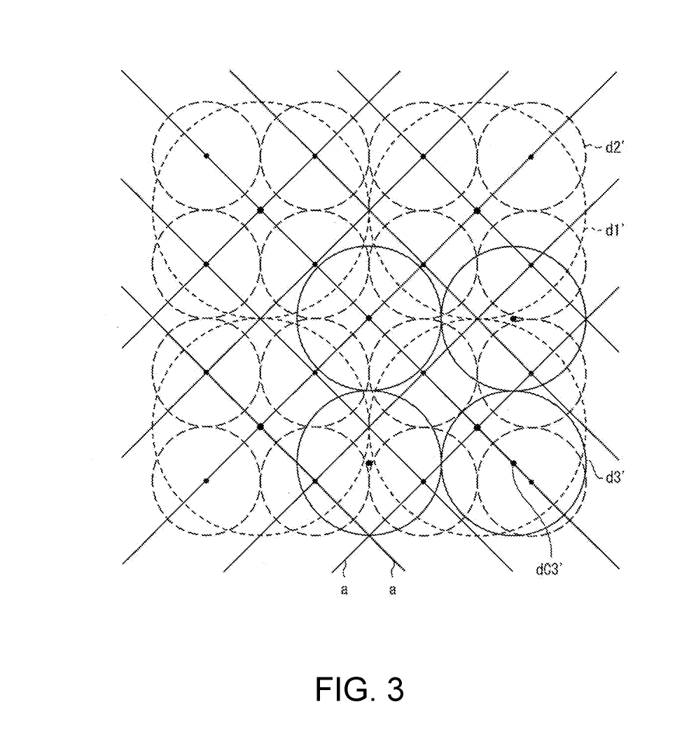

Another example of the arrangement of ink drops that constitute a segment layer is now described with reference to FIG. 3. FIG. 3 is a diagram schematically illustrating an arrangement of ink drops that constitute a segment layer formed according to another embodiment of the present disclosure.

In the present embodiment, the control part 11 further controls the head 1 such that ink is ejected at a resolution different from the resolution of the segment layer immediately below the segment layer being formed and at the resolution 2ⁿ times or (½)ⁿ times the resolution of the segment layer immediately below (where n is an integer equal to or greater than 1 and its upper limit is a predetermined value). By doing so, an ink droplet can be placed at a distance away from the center of a dot in the underlying segment layer. Accordingly, ink can be ejected to fill a larger area of the gap.

Specifics are as follows. In the present modification, as illustrated in FIG. 3, a dot that forms the segment layer immediately below is d1′. It is assumed that the device according to the present modification is set such that ink can be ejected at a resolution twice the resolution at which the segment layer of interest is formed. It is assumed that a dot formed when ink is ejected with twice higher resolution is a dot d2′. The control part 11 then forms a segment layer at a resolution different from both the resolution at which the dot d1′ is formed and the resolution at which the dot d2′ is formed. The dot formed here is a dot d3′. For example, when dots d1′ are formed at 600 dpi and dots d2′ are formed at 1200 dpi, dots d3′ are formed at 900 dpi.

Ejecting ink so as to form dots d3′ in this manner further ensures that a dot is formed at a location displaced from the center of the dot in the segment layer immediately below.

This example can also be described that segment layers are formed such that the center dC3′ which is the center of the dot d3′ does not overlap the line a formed by connecting the centers closest to each other, in the centers dC1′ and the centers dC2′ which are the centers of the dots d1′ and the dots d2′. It is desirable to form segment layers such that the center dC3′, which is the center of the dot d3′, does not overlap the line a formed by connecting the closest centers to each other, when the size of one dot sufficiently covers the area for one pixel. By contrast, when the size of one dot does not sufficiently cover the area for one pixel, creating a gap between dots, it is desirable to form segment layers such that the centers of dots overlap the line formed by connecting the closet centers to each other.

(Applications)

When the nozzle has a malfunction, the present disclosure can be used to suppress the effect of the malfunction on the three-dimensional object.

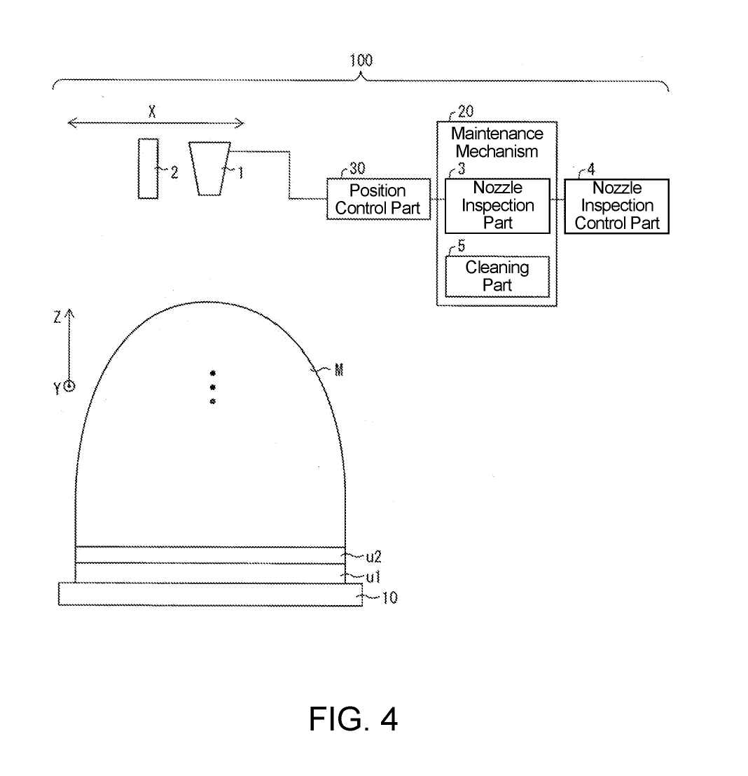

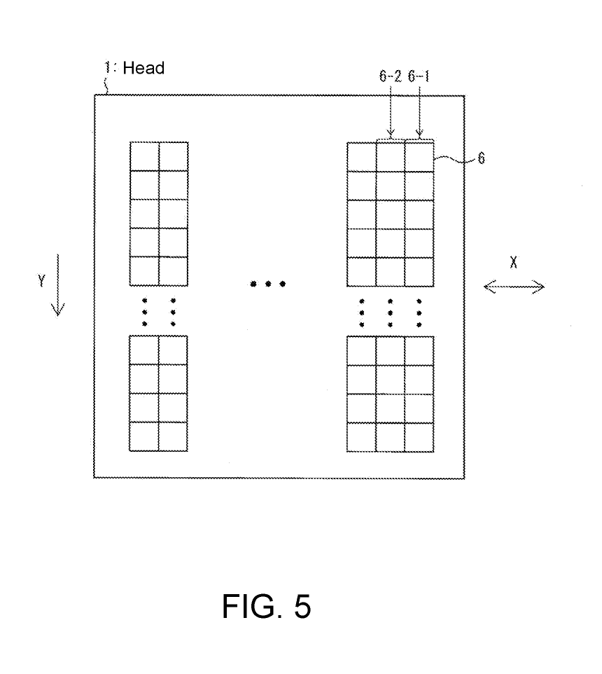

First, an embodiment of a nozzle inspection method in manufacturing a three-dimensional object is described with reference to FIG. 4 and FIG. 5. FIG. 4 is a diagram schematically illustrating the procedure for manufacturing a three-dimensional object M using the manufacturing device 100 for a three-dimensional object, as an embodiment of the nozzle inspection method. FIG. 5 is a diagram schematically illustrating an overall configuration of the head 1 in the manufacturing device 100 for a three-dimensional object for use in an embodiment of the nozzle inspection method. For convenience of explanation, the components having like functions as the components according to the embodiment previously described are denoted by the same numbers, and a description thereof is omitted. Here, the matters that have not been described in the foregoing embodiment will mainly be described.

As illustrated in FIG. 4, the manufacturing device 100 for a three-dimensional object includes a head 1, a UV-LED lamp 2, a maintenance mechanism 20, a nozzle inspection control part 4, a position control part 30, and a support stage 10. The maintenance mechanism 20 includes a nozzle inspection part 3 and a cleaning part 5.

The present embodiment describes the case when the head 1 makes a scan in the X direction on the support stage 10, the ejection target does not move but the head 1 moves. The present disclosure, however, is not limited to such an embodiment as long as the manufacturing device used is configured such that the head and the ejection target move relative to each other.

(Nozzles 6)

Nozzles 6 are for ejecting ink. As illustrated in FIG. 5, the head 1 has nozzle rows 6-1, 6-2 . . . , each including one or more nozzles 6 aligned in a row along the sub scanning direction (the Y direction). All the nozzles 6 are included in any one of the nozzle rows. In other words, the nozzles 6 are grouped (classified) into nozzle rows. The sub scanning direction is a direction orthogonal to the main scanning direction (the X direction).

Here, the kinds of ink ejected (ink for model material, ink for support material, and ink for coloring material) are different among the nozzle rows 6-1, 6-2 . . . In other words, all the nozzles in each individual nozzle row eject ink of the same kind.

(Maintenance Mechanism 20)

The maintenance mechanism 20 includes the nozzle inspection part 3 and the cleaning part 5. The maintenance mechanism 20 is configured to accommodate the head 1. The accommodated head 1 is inspected by the nozzle inspection part 3 or cleaned by the cleaning part 5. The maintenance mechanism 20 is provided at an end in the moving direction of the head 1 at a distance from the scanning range of the head 1.

(Nozzle Inspection Part 3)

The nozzle inspection part 3 is for inspecting the nozzles 6.

In the present embodiment, a “poor ejection nozzle” refers to, for example, the one that is unable to eject ink properly due to ink clogging or other reasons.

The nozzle inspection part used in the present disclosure may be a conventionally known one. In the present embodiment that is described below, a photosensor is used with which nozzle inspection is performed by interrupting an optical path. As another example of the nozzle inspection part, a nozzle check may be performed by checking the state of the ejection target after ink is ejected to a test ejection region. However, a photosensor is preferable in a case where the distance between the nozzle inspection part and the surface of the head that ejects ink is kept almost constant when the head or the support is moved in the Z direction, so that an error caused by the movement of the head or the support stage in the Z direction is prevented.

The inspection by the nozzle inspection part 3 is controlled by the nozzle inspection control part 4. A signal indicating an instruction based on when and which nozzle 6 is to be inspected is received from the nozzle inspection control part 4, and inspection is performed based on the instruction.

(Nozzle Inspection Control Part 4)

The nozzle inspection control part 4 is for controlling the inspection by the nozzle inspection part 3. Specifically, control is performed such that the inspection of the nozzles 6 is performed before a segment layer is formed using ink ejected from a nozzle 6 to be inspected and after the segment layer immediately below the segment layer of interest is formed. Poor injection of the nozzle 6 less frequently used can be found more effectively by inspecting the nozzle 6 more immediately before use.

The present embodiment describes the case in which the inspection by the nozzle inspection part 3 is controlled by control means installed in the manufacturing device 100 for a three-dimensional object. The present disclosure, however, is not limited to such an embodiment, and inspection may be performed every predetermined timing by manually operating the printer device.

(Cleaning Part 5)

The cleaning part 5 is for cleaning the nozzles 6. The cleaning part 5 includes a wiper for wiping the surface of the head 1 that has the nozzles 6 thereon and a washing device that stores cleaning liquid in which the head is immersed.

(Position Control Part 30)

The position control part 30 performs control such that the difference in distance between the nozzle inspection part 3 and the ink-ejecting surface of the head 1 falls within a predetermined length even when the head 1 moves.

Specifically, the position control part 30 detects the position in the Z-axis direction of the head, determines a displacement from the position in the Z-axis direction of the nozzle inspection part, and performs control such that the head 1 and/or the nozzle inspection part moves relatively in the Z-axis direction so as to eliminate the displacement. That is, the position of the head 1 is moved relatively in the Z-axis direction immediately before inspection is conducted, and then the head 1 is moved to the maintenance mechanism 20 so that inspection of the nozzles is performed.

If the nozzle inspection part 3 is provided at an extension portion of the head support for supporting the head 1 in a movable manner in the X direction, and the position of the nozzle inspection part 3 relative to the head 1 is fixed, the position control part 30 may not be provided. This is because the position of the nozzle inspection part 3 relative to the ink ejecting surface is fixed, and consequently, the distance between the position of ink when the nozzle inspection part 3 inspects the ink and the ink ejecting surface is kept constant.

In the present disclosure, at least one of the support stage and the head is movable in the deposition direction so that the difference in distance between the head and the nozzle inspection part can be controlled to be within a predetermined length.

While the present embodiment describes the case in which the support stage 10 is fixed and the head 1 is moved in the sub scanning direction (the Y direction) and the Z direction, the manufacturing device for a three-dimensional object according to the present disclosure can be achieved as long as the head and the ejection target move relative to each other. For example, the support stage may be moved in the Y direction (sub scanning direction) every time one scan by the head 1 is finished, or the support stage may be moved vertically downward every time one segment layer is formed.

(Method of Inspecting Nozzles while Three-Dimensional Object M is Being Manufactured)

A method of inspecting the nozzles 6 while manufacturing a three-dimensional object M is now described.

Before printing is started, the head 1 is accommodated in the maintenance mechanism 20.

Upon recognizing the start of printing (the start of manufacturing of a three-dimensional object), the nozzle inspection control part 4 recognizes a nozzle 6 to be used for forming the segment layer u1. For example, the nozzle inspection control part 4 itself creates data indicating when and which nozzle 6 is to be used for ejecting ink from image data of a three-dimensional object M, or acquires data created by hardware loaded with another print software, thereby recognizing a nozzle 6 to be used for forming a segment layer u1.

The nozzle inspection control part 4 recognizes the start of printing as follows. That is, the user inputs an instruction to start manufacturing to an input unit (not illustrated), and the nozzle inspection control part 4 receives the instruction and thereby recognizes the start of printing. When a single instruction to start specifies manufacturing of different kinds of three-dimensional objects, the timing when the kind of three-dimensional object to be manufactured is changed may be recognized as the start of printing.

The nozzle inspection control part 4 gives an instruction to the nozzle inspection part 3 to inspect the nozzle 6 to be used for forming the segment layer u1 and the nozzles 6 in the same nozzle row as the nozzle 6 to be used. In this manner, even when the total amount of ejection and the use frequency vary greatly among the kinds of ink, individual nozzles 6 that eject ink of the same kind can be inspected efficiently. In the manufacturing method for a three-dimensional object according to the present disclosure, the nozzles 6 may not be inspected for each nozzle row, and only a nozzle 6 to be used for forming a certain segment layer may be inspected.

The nozzle inspection part 3 inspects a nozzle 6 based on an instruction from the nozzle inspection control part 4. Specifically, ejection of ink is determined based on whether light is interrupted by an optical sensor. The nozzle inspection part 3 transmits the measurement result to the nozzle inspection control part 4. The nozzle inspection control part 4 recognizes, as a poor ejection nozzle, a nozzle whose ejection amount is zero or, if not zero, does not satisfy a predetermined amount within a predetermined time. The predetermined time and the predetermined amount are stored in a recording unit (not illustrated), and the nozzle inspection control part 4 reads information of the time and the amount from the recording unit and uses them to determine whether the nozzle is a non-ejection nozzle.

When there exists a nozzle 6 that is determined to be a poor ejection nozzle, the formation of the segment layer u1 is started while the effect of the nozzle is suppressed. A variety of methods are possible to suppress the effect. For example, the surface having the nozzle 6 thereon may be wiped by the cleaning part 5, and thereafter a slight amount of ink may be ejected (flushed) downward from the nozzle 6. This operation can suppress thickening in the poor ejection nozzle.

If a poor ejection nozzle is found in a subsequent inspection, the amount of ejection from the nozzle 6 per ejection may be reduced by increasing the number of scans necessary for forming an image of a unit region to shorten the manufacturing time. More specifically, the effect of the poor ejection nozzle can be suppressed by performing multipath printing or by increasing the number of paths in multipath printing.

Next, ink is ejected while the head 1 makes a scan in the X direction. In doing this, the UV-LED lamp 2 moves in the same manner as the head 1 since the UV-LED lamp 2 is adjacent to the head 1.

Ultraviolet radiation emitted from the UV-LED lamp 2 is applied to the ink ejected from the head 1. The ejected ink is thus hardened.

Next, the head 1 is moved in the Y direction for each scan of the head 1.

The moving distance of the head 1 is equal to the length in the sub scanning direction (the Y direction) of the ink ejecting region of the head 1 (nozzle rows 6-1, 6-2, etc.). That is, the present embodiment describes the case of single-path printing. In single-path printing, a unit image region (a print region of unit length square) is formed by a single main scan. The present disclosure is not limited to single-path printing but may be applicable to multipath printing. In other words, the moving distance in the sub scanning direction (the Y direction) of the head per scan is shorter than the length in the sub scanning direction (the Y direction) of the ink ejecting region (nozzle rows 6-1, 6-2, etc.) of the head. Therefore, the main scan is performed multiple times to print a unit image region.

In this way, the head 1 makes a scan in the X direction and moves in the Y direction to complete formation of the segment layer u1.

Next, the nozzle inspection control part 4 sends an instruction to the nozzle inspection part 3 to inspect the nozzle 6 to be used for forming the segment layer u2 and the nozzles 6 in the same nozzle row as the nozzle 6 to be used.

In this way, in an embodiment of the nozzle inspection method described here, control may be performed such that the nozzle that ejects ink for the first time after the start of manufacturing is inspected before forming a segment layer using the ink. Which nozzle applies as the nozzle that ejects ink for the first time can be determined from data indicating when and which of the nozzles described above is used to eject ink. Under such control, only a nozzle is inspected that has not been used up to segment layers formed before a certain segment layer and is used for the first time when the certain segment layer is formed, whereby the number of nozzles to be inspected can be reduced. As a result, the nozzle inspection time can be reduced, and the time until the next segment layer is formed can be reduced.

Before inspection of the nozzles, the position control part 30 controls the position of the nozzle inspection part 3 such that the difference in distance between the nozzle inspection part 3 and the ink ejecting surface of the head 1 falls within a predetermined length. For example, the position of the head 1 is also moved in the Z direction. Such control can keep the distance between the nozzle inspection part 3 and the ink ejecting surface of the head 1 almost constant even when the head 1 moves in the Z direction in order to deposit segment layers. In this way, the distance between the position of ink when the nozzle inspection part 3 inspects the ink and the ink ejecting surface is always kept constant, thereby suppressing the effect given by the movement of the head 1 in the Z direction on the inspection. The “predetermined length” can be set as appropriate based on, for example, the thickness of the layer. The information indicating the “predetermined length” is stored in a recording unit (not illustrated) and read by the position control part 30.

The present embodiment describes the case in which the position control part 30 adjusts the relative position between the head 1 and the nozzle inspection part 3 by moving the head 1 in the Z direction. The present disclosure, however, is not limited thereto. For example, the adjustment may be made by moving the support stage and/or the nozzle inspection part.

Next, to form the segment layer u2, the head 1 is moved in the Z direction. The present embodiment describes the case in which every time a segment layer is formed, the head 1 is moved in the Z direction (vertically upward). In the present disclosure, however, the support stage may be moved vertically downward.

The segment layer u2 is formed by allowing the head 1 to make a scan in the X direction and move in the Y direction, in the same manner as for the segment layer u1.

Similarly, segment layers are deposited one after another in the Z direction. Here, after a certain segment layer is formed, inspection is performed on the nozzles 6 in the same nozzle row as the nozzle 6 of the ink to be used when a segment layer deposited next is formed.

In the present embodiment, inspection described below is performed in addition to the inspection described so far.

That is, the nozzle inspection control part 4 controls the nozzle inspection part 3 so as to inspect a nozzle 6 that has not ejected ink a predetermined number of times and a nozzle 6 that has not ejected a predetermined amount of ink while a predetermined number of segment layers are formed. With such control, poor ejection of a nozzle 6 used less frequently can be detected.

The “predetermined number”, “predetermined number of times”, and “predetermined amount” may be set as appropriate based on tendency of thickening of ink or the size of a segment layer and may be changed according to the kind of ink. Furthermore, the information indicating “predetermined number”, “predetermined number of times”, and “predetermined amount” is stored in a recording unit (not illustrated) and read by the nozzle inspection control part 4.

The nozzle inspection part may be controlled to inspect a nozzle that does not satisfy the above-noted conditions within a predetermined time. For example, a nozzle that does not eject a predetermined amount of ink or does not perform a predetermined number of ejections may be inspected every one hour.

Independently of the inspection described so far, after a predetermined number of segment layers are formed, the nozzle row 6-1 is inspected, and after the nozzle row 6-1 is inspected, a predetermined number of segment layers are formed and thereafter the nozzle row 6-2 is inspected.

Similarly, inspection is performed for all the nozzle rows. For example, the nozzle rows 6-1, 6-2, . . . are inspected row by row in order, every layer. In this way, nozzles are divided into a plurality of groups and inspection is performed for each group, whereby a more accurate three-dimensional object can be manufactured. For example, when all the nozzles are inspected every time a certain number of segment layers are formed, the surface state of the segment layer formed most recently differs from the surface state of the other segment layers previously formed, in terms of dry state, wettability, and others. This is because the time until the next segment layer is formed on the surface differs by the time taken to perform nozzle inspection.

Then, in the nozzle inspection method described here, inspection is performed for each group, which can shorten the time until the next segment layer is formed. In addition, since inspection is performed every time certain layers are formed, the time from when a certain segment layer is formed to when the next segment layer is formed can be made more uniform throughout the period in which a three-dimensional object is manufactured.

Information indicating which nozzle 6 belongs to which group (group information) is stored in a recording unit (not illustrated) in advance, and the nozzle inspection control part 4 receives this information from the recording unit.

The case where the nozzles are grouped into nozzle rows and inspection is performed for each nozzle row in order has been described. However, the nozzles may not be grouped into nozzle rows. For example, the nozzle rows may be further subdivided. For example, one or more nozzle rows may be divided into the upstream side and the downstream side in the sub scanning direction, so that the nozzle row(s) on the upstream side is inspected before formation of a certain segment layer, and the nozzle row(s) on the downstream side is inspected before formation of another segment layer.

An embodiment other than the embodiment in which groups are formed and each group is inspected in order may be employed. For example, at least a part of predetermined nozzles 6 may be inspected every time a predetermined number of segment layers are formed, every time a predetermined time has elapsed. For example, nozzles (group) used less frequently are selected in advance, and the nozzle check may be repeated at predetermined timing.

(Method of suppressing effect of poor ejection nozzle)

When a malfunction of a nozzle is detected through the inspection as described above, the manufacturing device for a three-dimensional object according to the present disclosure or the manufacturing method for a three-dimensional object according to the present disclosure can be used to suppress the effect of the malfunction.

More specifically, even when a certain dot is larger or smaller than a predetermined size due to a malfunction of a nozzle, its periphery is filled not only with the dots in the same segment layer but also with the dots in the overlying segment layer. Compared with a case without adopting this method in which dots from the nozzle having the malfunction are deposited, dots from a nozzle different from the nozzle having the malfunction are naturally arranged near the dots ejected from the nozzle having the malfunction, which will reduce the effect of the malfunction.

In addition, since the resolution is changed from that of the segment layer immediately below, the effect caused by change in resolution is greater than the effect caused by the malfunction of the nozzle, which will even further reduce the effect of the malfunction of the nozzle on the three-dimensional object.

[Implementation Example By Software]

The control block of the control part 11 may be implemented by a logic circuit (hardware), for example, formed on an integrated circuit (IC chip) or may be implemented by software using a central processing unit (CPU).

In the latter case, the control part 11 includes a CPU configured to execute instructions of a program which is software for implementing the functions, a read only memory (ROM) or a storage device (they are referred to as “recording medium”) encoded with the program and various data in a computer (or CPU)-readable format, and a random access memory (RAM) configured to expand the program. The computer (or CPU) then reads and executes the program from the recording medium to achieve the object of the present disclosure. Examples of the recording medium that can be used include “non-transitory tangible medium” such as tape, disc, card, semiconductor memory, and programmable logic circuit. Alternatively, the program may be supplied to the computer through any transmission media that can transmit the program (for example, communication network and broadcast wave). The present disclosure can be implemented in the form of data signals embedded in carrier waves that embody the program through electronic transmission.

[Remarks]

As described above, in an embodiment of the manufacturing method for a three-dimensional object according to the present disclosure in which a three-dimensional object M is manufactured by depositing segment layers u1, u2 . . . , ink is ejected such that the center of an ink droplet of at least part of ink ejected from the head 1 for forming the segment layer u2 does not overlap the center of an ink droplet that forms the segment layer u1 immediately below.

The manufacturing device 100 for a three-dimensional object is a manufacturing device 100 for a three-dimensional object in which a three-dimensional object M is manufactured by depositing segment layers u1, u2 . . . The manufacturing device 100 includes the control part 11 configured to control the head 1 ejecting ink. The control part 11 controls the head 1 such that the center of an ink droplet of at least part of ink ejected for forming the segment layer u2 does not overlap the center of an ink droplet that forms the segment layer u1 immediately below and that ink is ejected at a resolution different from the resolution of the segment layer immediately below the segment layer being formed.

Ink in the overlying segment layer u2 is ejected so as not to overlap the center dC1 of the dot d1 of ink in the underlying segment layer u1, and the resolution is changed, whereby at least part of the ink can easily fill between dots d1 of ink in the underlying segment layer u1. This reduces the surface roughness of the segment layer.

In an embodiment of the manufacturing method for a three-dimensional object, the control part 11 changes the amount of ink ejected from the head 1 according to resolution.

The diameters of dots are changed so that placing ink drops in the gap between dots d1 of ink that forms the underlying segment layer u1 can be easily controlled. For example, a segment layer with high resolution is formed with small dots, so that the depressions in the segment layer immediately below can be filled with ink efficiently. For example, when a segment layer with high resolution is formed with large dots, the segment layer immediately below, including the depressions, can be covered, which is also capable of planarizing the surface roughness. Accordingly, the roughness of the segment layer can be planarized efficiently.

In an embodiment of the manufacturing method for a three-dimensional object, the three-dimensional object M is manufactured by depositing unit layers C1, C2 . . . each including two segment layers. The number of segment layers that form each of the unit layers C1 , C2 . . . is equal in at least part of the three-dimensional object M. The control part 11 sets a lower resolution for a segment layer on the lower side in the gravity direction, in each of the unit layers C1, C2 . . . formed with the equal number of segment layers.

When a segment layer other than the lowest layer in each unit layer is formed, an ink droplet can be suitably placed in a gap between dots of ink in the segment layer immediately below.

In an embodiment of the manufacturing method for a three-dimensional object, the resolution of at least a part of other segment layers, among the segment layers, different from the segment layer with the lowest resolution is set 2ⁿ times (n is an integer equal to or greater than 1) the lowest resolution.

Dots in the segment layer with high resolution are arranged at four corners of the segment layer with low resolution, thereby efficiently filling the depressions at corners.

In an embodiment of the manufacturing method for a three-dimensional object, ink is ejected at a resolution different from the resolution of the segment layer u1 immediately below the segment layer u2 being formed and the resolution 2ⁿ times or (½)ⁿ times the resolution of the segment layer u1 immediately below (where n is an integer equal to or greater than 1 and its upper limit is a predetermined value).

This control allows an ink droplet to be placed at a distance away from the center dC1 of the underlying segment layer u 1. Accordingly, the dots can be arranged across the respective pixel regions between the segment layers adjacent to each other in the deposition direction, thereby achieving the effect of suppressing banding (striping). This can further planarize the surface roughness.

An embodiment of the manufacturing method for a three-dimensional object includes a pressure application step in which pressure is applied to planarize the outermost surface of the unit layer using the roller 12.

Pressure is applied to the outermost surface of the unit layer to facilitate dots in the segment layer on the upper side to enter between dots in the segment layer on the lower side in a unit layer, thereby promoting planarization efficiently. In particular, in a mode in which the amount of ejection is changed such that the dot diameter decreases as the resolution increases, a small dot in the segment layer on the upper side easily enters between large dots in the segment layer on the lower side, which enables more effective planarization.

What is claimed is:

1. A manufacturing method for a three-dimensional object for manufacturing a three-dimensional object by depositing segment layers, the manufacturing method comprising:
ejecting droplets such that a center of a droplet of at least a part of the droplets ejected from a head for forming a segment layer does not overlap a center of a droplet that forms another segment layer immediately below; and
ejecting the droplets at a resolution different from a resolution of the other segment layer immediately below the segment layer being formed.

2. The manufacturing method for a three-dimensional object according to claim 1, wherein
the droplets ejected from the head have variable amounts according to the resolution.

3. The manufacturing method for a three-dimensional object according to claim 1, wherein
the three-dimensional object is manufactured by depositing unit layers each including a plurality of segment layers,
the number of segment layers included in the unit layer is equal in at least a part of the three-dimensional object, and
in each of the unit layers formed with an equal number of segment layers, a resolution is set lower in a segment layer on a lower side in a gravity direction.

4. The manufacturing method for a three-dimensional object according to claim 1, wherein
among the segment layers, the resolution of at least a part of other segment layers different from a segment layer with a lowest resolution is set to 2ⁿ times the lowest resolution, where n is an integer equal to or greater than 1.

5. The manufacturing method for a three-dimensional object according to claim 2, wherein
the droplets are ejected at a resolution different from the resolution of the other segment layer immediately below the segment layer being formed and a resolution 2ⁿ times or (½)ⁿ times the resolution of the segment layer immediately below,
where n is an integer equal to or greater than 1 and an upper limit of n is a predetermined value.

6. The manufacturing method for a three-dimensional object according to claim 3, wherein the manufacturing method comprising:
a pressure application step of applying pressure to planarize an outermost surface of the unit layer.

7. A manufacturing device for a three-dimensional object for manufacturing a three-dimensional object by depositing segment layers, the manufacturing device comprising:
a head control part, configured to control a head for ejecting droplets, wherein
the head control part controls the head such that a center of a droplet of at least a part of the droplets ejected for forming a segment layer does not overlap a center of a droplet that forms another segment layer immediately below, and that the droplets are ejected at a resolution different from the resolution of the other segment layer immediately below the segment layer being formed.

8. The manufacturing method for a three-dimensional object according to claim 2, wherein
the three-dimensional object is manufactured by depositing unit layers each including a plurality of segment layers,
a number of segment layers included in the unit layer is equal in at least part of the three-dimensional object, and
in each of the unit layers formed with an equal number of segment layers, a resolution is set lower in a segment layer on a lower side in a gravity direction.

9. The manufacturing method for a three-dimensional object according to claim 2, wherein
among the segment layers, a resolution of at least a part of other segment layers different from a segment layer with a lowest resolution is set to 2ⁿ times the lowest resolution, where n is an integer equal to or greater than 1.

10. The manufacturing method for a three-dimensional object according to claim 3, wherein
among the segment layers, a resolution of at least a part of other segment layers different from a segment layer with a lowest resolution is set to 2ⁿ times the lowest resolution, where n is an integer equal to or greater than 1.

11. The manufacturing method for a three-dimensional object according to claim 3, wherein
the droplets are ejected at a resolution different from the resolution of the other segment layer immediately below the segment layer being formed and a resolution 2ⁿ times or (½)ⁿ times the resolution of the segment layer immediately below,
where n is an integer equal to or greater than 1 and an upper limit of n is a predetermined value.

12. The manufacturing method for a three-dimensional object according to claim 4, wherein
the droplets are ejected at a resolution different from the resolution of the other segment layer immediately below the segment layer being formed and a resolution 2ⁿ times or (½)ⁿ times the resolution of the segment layer immediately below,
where n is an integer equal to or greater than 1 and an upper limit of n is a predetermined value.
